(19) United States
(12) Patent Application Publication
(10) Pub. No.: US 2026/0048495 A1
(43) Pub. Date: Feb. 19, 2026

(54) TOOL STORAGE DEVICE

(71) Applicant: Wen-Yi CHENG, Taichung City (TW)

(72) Inventor: Wen-Yi CHENG, Taichung City (TW)

(21) Appl. No.: 18/806,811

(22) Filed: Aug. 16, 2024

(51) Int. Cl. B25H 3/00; B65D 25/10; B65D 81/02

(52) U.S. Cl. CPC B25H 3/006; B65D 25/10; B65D 81/022; B25H 3/003

(57) ABSTRACT

A tool storage device includes a storage unit including a plurality of base plates, and a plurality of bent parts that are alternately connected to the base plates and that are bendable, a holding unit disposed on an inner surface of the storage unit, a first connecting member, a second connecting member, and a protective pad disposed at an outer side of the storage unit, and having a plurality of connecting portions respectively corresponding in position to the bent parts. The first connecting member and the second plate are disposed on two of the base plates located at two opposite ends. The tool storage device is switchable between an unfolded state and a folded state. In the folded state, the tool storage device defines an accommodating space for accommodating the holding unit, the first connecting member is connected to the second connecting member, and the connecting portions are arcuately stretched.

### FIELD

The disclosure relates to a tool storage device, and more particularly to a tool storage device having a pleasant appearance and is impact resistant.

### BACKGROUND

A conventional tool storage device that is used for receiving a screwdriver and a screwdriver bit is typically a tool box. The tool box includes a box body and a cover that covers the box body. The box body is used for receiving the screwdriver and the screwdriver bit. The cover usually is separably disposed on the box body or is pivotally connected to the box body.

However, the tool storage device may often experience collision while being carried around or be dropped. When the tool storage device experiences collision or is dropped, the outer surface and a junction of the box body and the cover of the tool storage device may be damaged. Furthermore, the tool storage device is usually bulky which is inconvenient to carry or store.

### SUMMARY

Therefore, an object of the disclosure is to provide a tool storage device that can alleviate at least one of the drawbacks of the prior art.

According to the disclosure, the tool storage device includes a storage unit, a holding unit, a first connecting member, a second connecting member, and a protective pad.

The storage unit includes a plurality of base plates that extend along a lengthwise direction, and a plurality of bent parts. The bent parts are alternately connected to the base plates in a widthwise direction that is perpendicular to the lengthwise direction and are bendable. A number of the base plates minus one is equal to a number of the bent parts. Each of the base plates has an outer plate surface and an inner plate surface that are oppositely arranged along a thickness direction perpendicular to the lengthwise direction and the widthwise direction. Each of the bent parts has an outer folding surface that interconnects two adjacent ones of the base plates and that is located at a same side as the outer plate surfaces of the base plates. Two of the base plates that are respectively located at two opposite ends along the widthwise direction are respectively defined as a first base plate and a second base plate, others of the base plates are respectively defined as a plurality of intermediate base plates.

The holding unit includes a plurality of holding members that are disposed on at least one of the inner plate surfaces of the base plates.

The first connecting member is disposed on the first base plate.

The second connecting member is disposed on the second base plate and is capable of being connected to the first connecting member.

The protective pad is disposed at one side of the storage unit that is opposite to the holding unit and has a plurality of connecting portions that respectively correspond in position to the bent parts of the storage unit.

The tool storage device is switchable between an unfolded state and a folded state. When the tool storage device is in the unfolded state, the first connecting member is distal from the second connecting member. When the tool storage device is in the folded state, the tool storage device surrounds and defines an accommodating space for accommodating the holding members of the holding unit, the first connecting member is connected to the second connecting member, and the connecting portions are arcuately stretched.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of a first embodiment of a tool storage device, according to the disclosure, in an unfolded state.

FIG. 2 is another perspective view of the first embodiment taken from another angle.

FIG. 3 is a sectional view taken along line III-III of FIG. 1.

FIG. 4 is a perspective view of a storage unit, a first connecting member, and a second connecting member of the first embodiment.

FIG. 5 is an enlarged view of a portion A in FIG. 3

FIG. 6 is a perspective view of the first embodiment in a folded state.

FIG. 7 is a perspective view of a second embodiment of a tool storage device, according to the disclosure, in a folded state.

FIG. 8 is a fragmentary partly sectional view of a third embodiment of a tool storage device, according to the disclosure, in an unfolded state.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

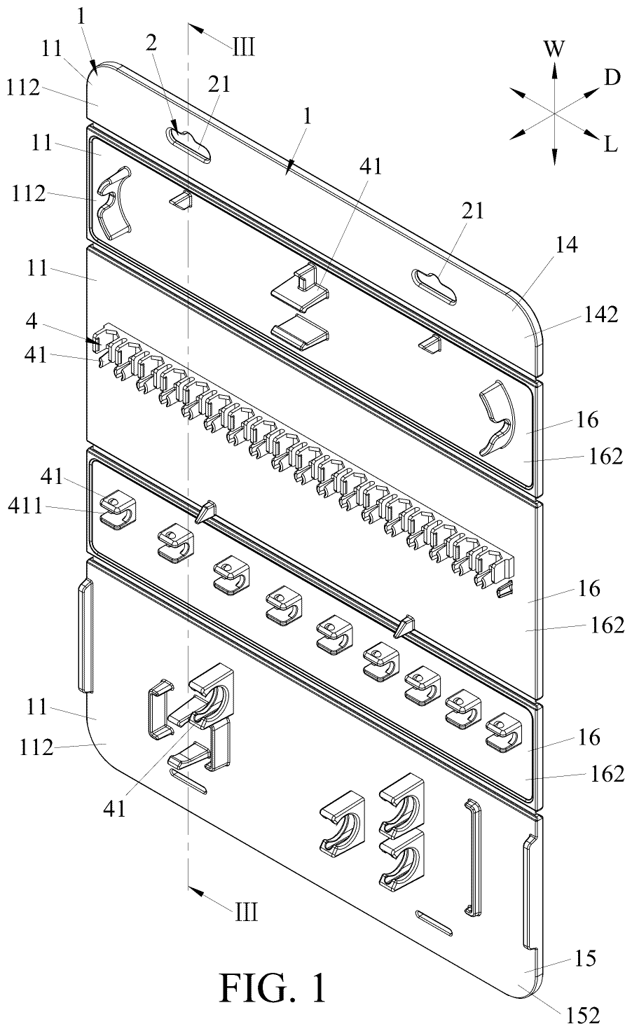

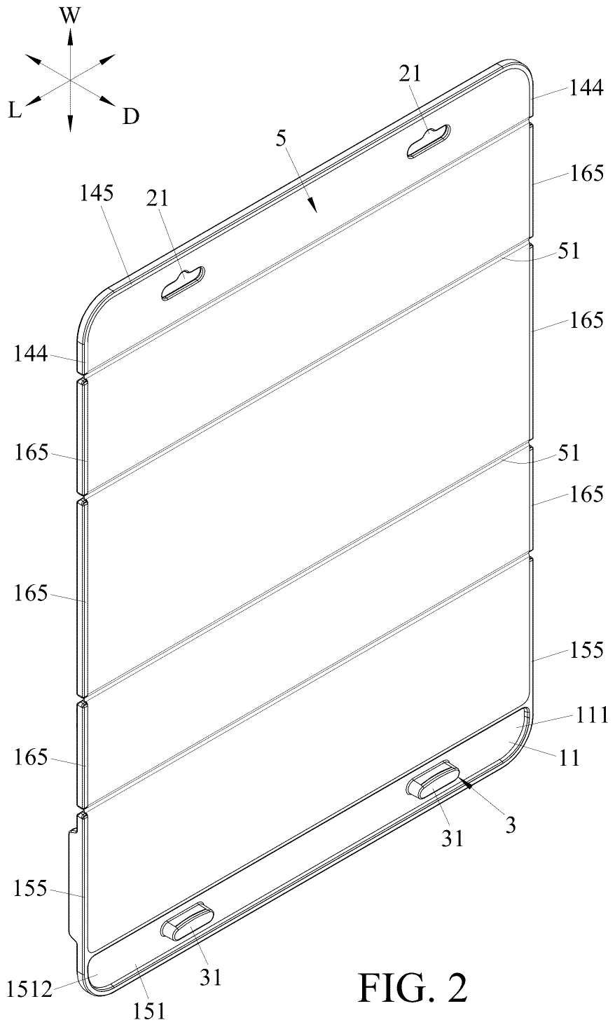

Referring to FIGS. 1 and 2, a first embodiment of a tool storage device according to the disclosure includes a storage unit 1, a first connecting member 2, a second connecting member 3, a holding unit 4, and a protective pad 5.

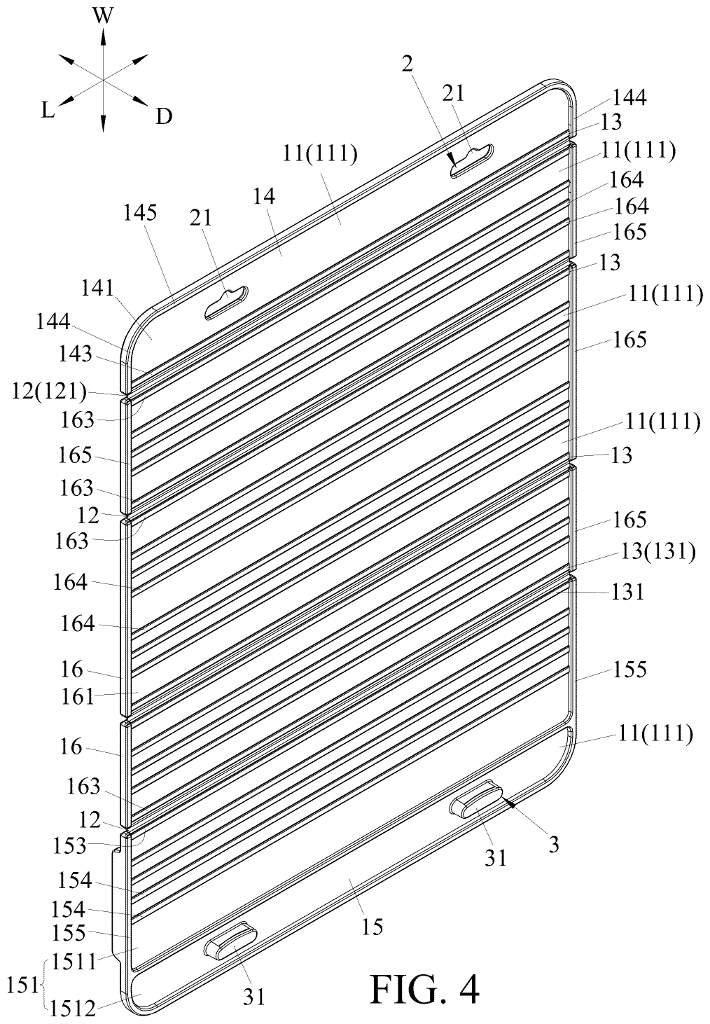

Referring to FIGS. 1, 3 and 4, the storage unit 1 includes a plurality of base plates 11 that extend along a lengthwise direction (L), a plurality of bent parts 12 that extend along the lengthwise direction (L), that are alternately connected to the base plates 11 in a widthwise direction (W) perpendicular to the lengthwise direction (L), and that are bendable, and a plurality of support members 13 that respectively correspond to the bent parts 12. The number of the base plates 11 minus one is equal to the number of the bent parts 12, and the number of the support members 13 is identical to the number of the bent parts 12.

Referring to FIGS. 1, 4 and 5, in this embodiment, the number of the base plates 11 is five, the number of the bent parts 12 is four, and the number of the support members 13 is four.

Each of the base plates 11 has an outer plate surface 111 and an inner plate surface 112 that are oppositely arranged along a thickness direction (D) perpendicular to the lengthwise direction (L) and the widthwise direction (W). In this embodiment, each of the base plates 11 is made of a rigid plastic material.

Each of the bent parts 12 has an outer folding surface 121 that interconnects two adjacent ones of the base plates 11 and that is located at a same side as the outer plate surfaces 111 of the base plates 11, and a groove 122 that is defined by the outer folding surface 121 and that extends along the lengthwise direction (L). Each of the bent parts 12 may be bent more easily through the groove 122. In this embodiment, each of the bent parts 12 is made of a rigid plastic material, but not limited thereto. For example, in some embodiments, each of the bent parts 12 may be a single hinge or a plurality of hinges.

Each of the support members 13 includes two protruding bars 131 that are respectively located at two opposite sides of the outer folding surface 121 of a corresponding one of the bent parts 12 in the widthwise direction (W) and that are respectively connected to the outer plate surfaces 11 of two of the base plates 11 between which the corresponding one of the bent parts 12 is connected. Each of the protruding bars 131 of each of the support members 13 extends along the lengthwise direction (L). Each of the support members 13 has a movable space 132 that is cooperatively defined by the protruding bars 131, the outer folding surface 121 of the corresponding one of the bent parts 12, and the outer plate surfaces 111 of the two of the base plates 11 between which the corresponding one of the bent parts 12 is connected and that extends along the lengthwise direction (L). It should be noted that the movable space 132 of each of the support members 13 has the groove 122 of the corresponding one of the bent parts 12. In this embodiment, for each of the support members 13, each of the protruding bars 131 is made of a rigid plastic material.

Two of the base plates 11 that are respectively located at two opposite ends along the widthwise direction (W) are respectively defined as a first base plate 14 and a second base plate 15, others of the base plates 11 are respectively defined as a plurality of intermediate base plates 16.

The outer plate surface 111 of the first base plate 14 is defined as a first outer plate surface 141, the inner plate surface 112 of the first base plate 14 is defined as a first inner plate surface 142, and one of the protruding bars 131 of the support members 13 that is connected to the first outer plate surface 141 is defined as a first protruding bar 143. The first base plate 14 further includes two first outer edge portions 144 that are connected to the first outer plate surface 141 and that are located at two opposite sides of the first outer plate surface 141 along the lengthwise direction (L), and a first end edge portion 145 that interconnects the first outer edge portions 144 and that is opposite to an adjacent one of the bent parts 12 in the widthwise direction (W). The first outer edge portions 144 are connected to two opposite sides of the first protruding bar 143 along the lengthwise direction (L). In the thickness direction (D), each of the first outer edge portions 144 protrudes more than the first protruding bar 143.

The outer plate surface 111 of the second base plate 15 is defined as a second outer plate surface 151, the inner plate surface 112 of the second base plate 15 is defined as a second inner plate surface 152, and one of the protruding bars 131 of the support members 13 that is connected to the second outer plate surface 151 is defined as a second protruding bar 153. The second outer plate surface 151 has a base surface portion 1511 that is connected to an adjacent one of the bent parts 12, and an engaging surface portion 1512 that is spaced apart from the base surface portion 1511 in the widthwise direction (W). The second base plate 15 further includes a plurality of ribs 154 that protrude from the base surface portion 1511 of the second outer plate surface 151, that extend along the lengthwise direction (L), and that are spaced apart from each other in the widthwise direction (W), and two second outer edge portions 155 that are connected to the base surface portion 1511 and the engaging surface portion 1512 of the second outer plate surface 151 and that are located at two opposite sides of the second outer plate 151 along the lengthwise direction (L). The second outer edge portions 155 are connected to two opposite sides of the second protruding bar 153 along the lengthwise direction (L). In the thickness direction (D), each of the second outer edge portions 155 protrudes more than the second protruding bar 153 and the ribs 154 of the second base plate 15.

The outer plate surface 111 of each of the intermediate base plates 16 is defined as an intermediate outer plate surface 161, the inner plate surface 112 of each of the intermediate base plates 16 is defined as an intermediate inner plate surface 162, and others of the protruding bars 131 of the support members 13 are respectively defined as a plurality of intermediate protruding bars 163. Each of the intermediate base plate 16 further includes a plurality of ribs 164 that protrude from the intermediate outer plate surface 161, that extend along the lengthwise direction (L), and that are spaced apart from each other along the widthwise direction (W), and two intermediate outer edge portions 165 that are connected to the intermediate outer plate surface 161 and that are located at two opposite sides of the intermediate outer plate surface 161 along the lengthwise direction (L). For each of the intermediate base plates 16, the intermediate outer edge portions 165 are connected to two opposite sides of two of the intermediate protruding bars 163 that are connected to the intermediate base plate 16 along the lengthwise direction (L). For each of the intermediate base plates 16, in the thickness direction (D), each of the intermediate outer edge portions 165 protrudes more than the two of the intermediate protruding bars 163 that are connected to the intermediate base plate 16.

The first connecting member 2 is disposed on the first base plate 14. Specifically, the first connecting member 2 has two through holes 21 that extend through the first outer plate surface 141 and the first inner plate surface 142 and that are spaced apart from each other along the lengthwise direction (L).

The second connecting member 3 is disposed on the second base plate 15 and is capable of being connected to the first connecting member 2. Specifically, the second connecting member 3 has two protrusions 31 that are disposed on the engaging surface portion 1512 of the second outer plate surface 151, that are spaced apart from each other in the lengthwise direction (L), and that are able to respectively and removably engage the through holes 21 of the first connecting member 2. In this embodiment, each of the protrusions 31 is made of a rigid plastic material.

It should be noted that the number of the through holes 21 and the number of the protrusions 31 may be one, three or more, and is not limited to the numbers in the first embodiment. Furthermore, in some embodiments, the first connecting member 2 may have protrusions and the second connecting member 3 may have through holes, and the configurations of the first connecting member 2 and the second connecting member 3 may not be limited to the ones in the first embodiment.

Referring to FIG. 1, the holding unit 4 includes a plurality of holding members 41 that are disposed on the intermediate inner plate surfaces 162 of the intermediate base plates 16 and the second inner plate surface 152 of the second base plate 15. Specifically, each of the holding members 41 has an engaging groove 411 that is adapted for disposing a hand tool (not shown). The hand tool may be a screwdriver, a screwdriver bit, etc.

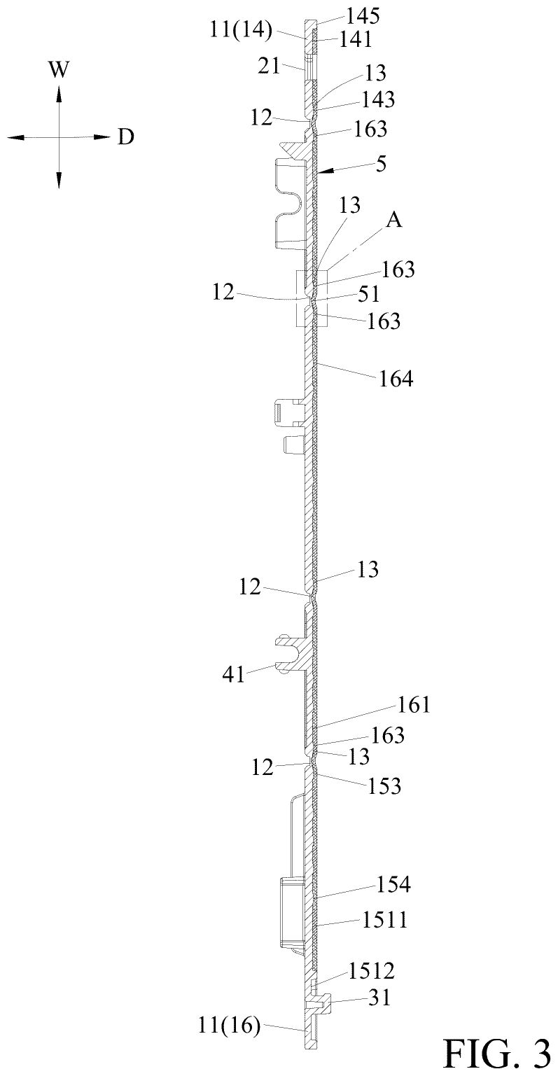

Referring to FIGS. 3 to 5, the protective pad 5 is disposed at one side of the storage unit 1 that is opposite to the holding unit 4. Specifically, in the first embodiment, the protective pad 5 is made of a pliable material, and is adhered to and cover the first outer plate surface 141, the intermediate outer plate surfaces 161 of the intermediate base plates 16, the base surface portion 1511 of the second outer plate surface 151, the outer folding surfaces 121 of the bent parts 12, the first protruding bar 143, the second protruding bar 153, the intermediate protruding bars 163, the ribs 154 of the second base plate 15, and the ribs 164 of the intermediate base plates 16. The protective pad 5 has a plurality of connecting portions 51 that respectively correspond in position to the bent parts 12 of the storage unit 1. Through the ribs 154 of the second base plate 15 and the ribs 164 of the intermediate base plates 16, the protective pad 5 may be more tightly connected to the storage unit 1 and may not be easily disconnected. It should be noted that, in some embodiments, the protective pad 5 may not be adhered to the outer folding surfaces 121 of the bent parts 12.

Referring to FIGS. 2, 5 and 6, edges of the protective pad 5 are adjacent to the first outer edge portions 144 and the first end edge portion 145 of the first base plate 14, the second outer edge portions 155 of the second base plate 15, and the intermediate outer edge portions 165 of each of the intermediate base plates 16. In addition, in the thickness direction (D), the edges of the protective pad 5 are substantially flush with the first outer edge portions 144, the first end edge portion 145, the second outer edge portions 155, and the intermediate outer edge portions 165 of each of the intermediate base plates 16. As the result, the protective pad 5 is smoothly disposed at the outer side of the storage unit 1 such that the protective pad 5 has a pleasant appearance without unnecessary wrinkles, and, when a user touches each junction between the protective pad 5 and the first outer edge portions 144, the first end edge portion 145, the second outer edge portions 155, and the intermediate outer edge portions 165 of each of the intermediate base plates 16, the user may feel a smooth and pleasant sensation.

The tool storage device is switchable between an unfolded state and a folded state.

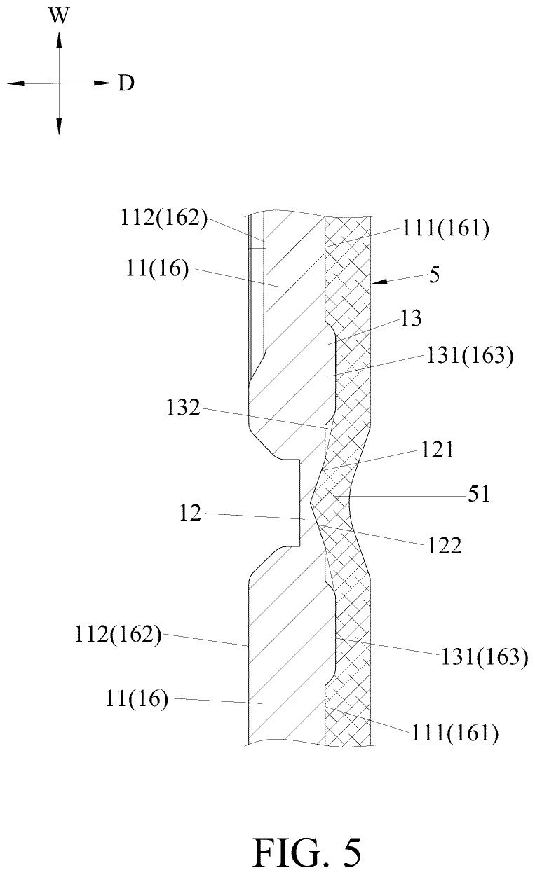

When the tool storage device is in the unfolded state (see FIG. 2), the through holes 21 of the first connecting member 2 is distal from the protrusions 31 of the second connecting member 3, and a portion of the connecting portions 51 of the protective pad 5 is bent and is accommodated in the movable space 132 of a corresponding one of the support members 13 (see FIGS. 3 and 5), so that the protective pad 5 remains smooth and is aesthetically pleasing.

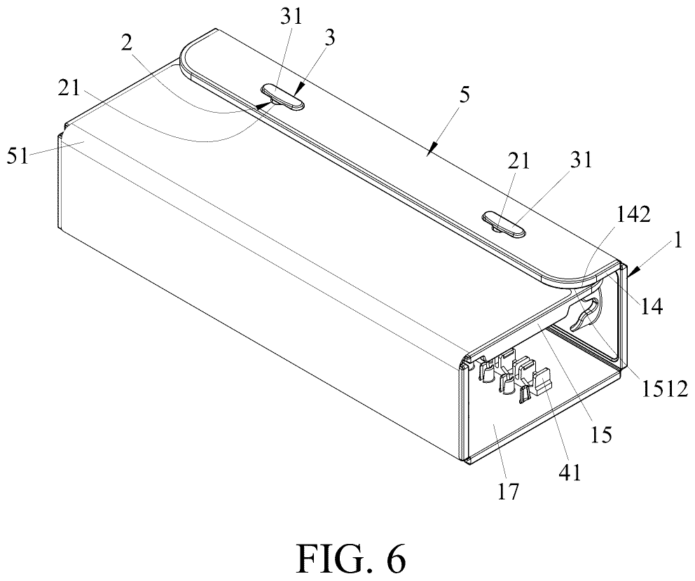

When the tool storage device is in the folded state (see FIG. 6), the tool storage device surrounds and defines an accommodating space 17 for accommodating the holding members 41 of the holding unit 4, the first base plate 14 overlaps the engaging surface portion 1512 of the second outer plate surface 151, the protrusions 31 of the second connecting member 3 respectively extend through the through holes 21 of the first connecting member 2 from a side at which the first inner plate surface 142 is located and respectively engage the through holes 21, and the connecting portions 51 of the protective pad 5 are arcuately stretched. At this time, the protective pad 5 substantially covers an outer side of the storage unit 1 to provide a good protection to the storage unit 1. In this embodiment, the accommodating space 17 is a quadrilateral prism.

Therefore, the tool storage device of the disclosure has the following advantages.

First, when the tool storage device experiences collision or is dropped, the protective pad 5 may protect the tool storage device from the impact.

Second, since the edges of the protective pad 5 are substantially flush with the first outer edge portions 144, the first end edge portion 145, the second outer edge portions 155, and the intermediate outer edge portions 165 of each of the intermediate base plates 16 in the thickness direction (D), so that the edges of the protective pad 5 are smooth and have a pleasant appearance.

Third, the movable spaces 132 of the support members 13 provide a space for accommodating the connecting portions 51 of the protective pad 5, so that when the tool storage device is in the unfolded state, the connecting portions 51 will not protrude or wrinkle, and the tool storage device maintains a pleasant appearance.

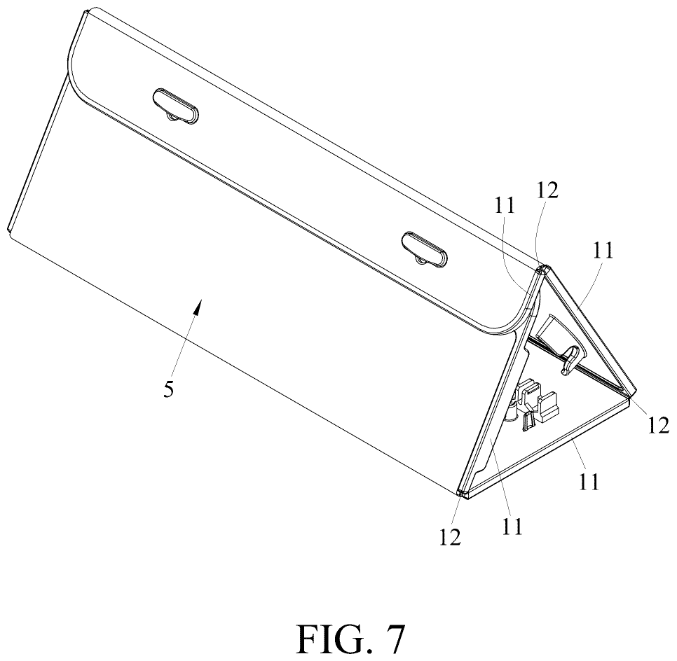

Referring to FIG. 7, a second embodiment of the tool storage device according to the disclosure is illustrated. The difference between the second embodiment and the first embodiment is that, in the second embodiment, the number of the base plate 11 is four, and the number of the bent parts 12 is three, so the accommodating space 17 is a triangular prism when the second embodiment of the tool storage device is in the folded state. The main difference is the shape of the accommodating space 17; therefore, the second embodiment also has a pleasant appearance and is impact resistant as the first embodiment.

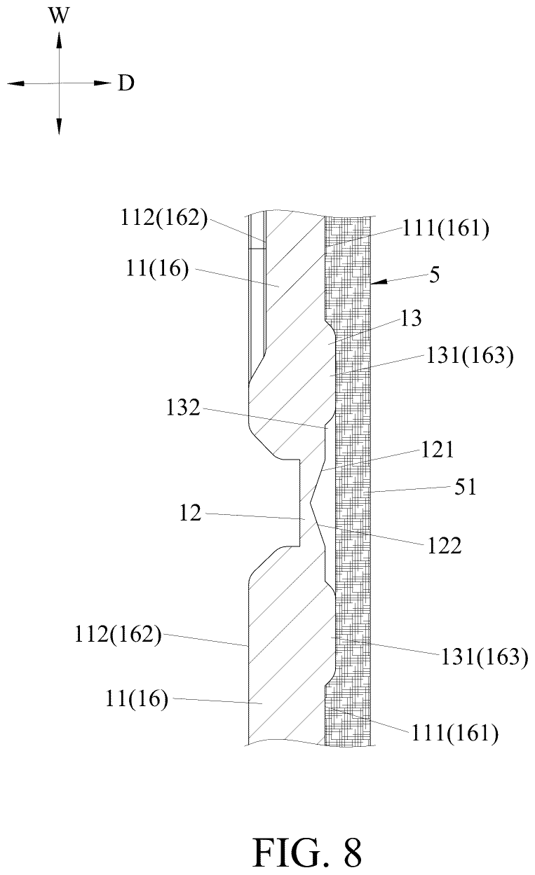

Referring to FIG. 8, a third embodiment of the tool storage device according to the disclosure is illustrated. The difference between the third embodiment and the first embodiment is that, in the third embodiment, the protective pad 5 is made of an elastic material, and the connecting portions 51 of the protective pad 5 are not adhered to the outer folding surfaces 121 of the bent parts 12, so that when the tool storage device is in the unfolded state, the connecting portions 51 are spaced apart from the outer folding surfaces 121 and shrink to remain flat. Therefore, the third embodiment also has a pleasant appearance and is impact resistant as the first embodiment.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A tool storage device comprising:
a storage unit including a plurality of base plates that extend along a lengthwise direction, and a plurality of bent parts, said bent parts being alternately connected to said base plates in a widthwise direction that is perpendicular to the lengthwise direction and being bendable, a number of said base plates minus one being equal to a number of said bent parts, each of said base plates having an outer plate surface and an inner plate surface that are oppositely arranged along a thickness direction perpendicular to the lengthwise direction and the widthwise direction, each of said bent parts having an outer folding surface that interconnects two adjacent ones of said base plates and that is located at a same side as said outer plate surfaces of said base plates, two of said base plates that are respectively located at two opposite ends along the widthwise direction being respectively defined as a first base plate and a second base plate, others of said base plates being respectively defined as a plurality of intermediate base plates;
a holding unit including a plurality of holding members that are disposed on at least one of said inner plate surfaces of said base plates;
a first connecting member disposed on said first base plate;
a second connecting member disposed on said second base plate and being capable of being connected to said first connecting member; and
a protective pad disposed at one side of said storage unit that is opposite to said holding unit and having a plurality of connecting portions that respectively correspond in position to said bent parts of said storage unit,
said tool storage device being switchable between an unfolded state and a folded state, when said tool storage device is in the unfolded state, said first connecting member being distal from said second connecting member, when said tool storage device is in the folded state, said tool storage device surrounding and defining an accommodating space for accommodating said holding members of said holding unit, said first connecting member being connected to said second connecting member, and said connecting portions being arcuately stretched.

2. The tool storage device as claimed in claim 1, wherein said outer plate surface of said first base plate is defined as a first outer plate surface, said outer plate surface of said second base plate being defined as a second outer plate surface, said outer plate surface of each of said intermediate base plates being defined as an intermediate outer plate surface, said first base plate further including two first outer edge portions that are connected to said first outer plate surface and that are located at two opposite sides of said first outer plate surface along the lengthwise direction, said second base plate further including two second outer edge portions that are connected to said second outer plate surface and that are located at two opposite sides of said second outer plate surface along the lengthwise direction, each of said intermediate base plates further including two intermediate outer edge portions that are connected to said intermediate outer plate surface and that are located at two opposite sides of said intermediate outer plate surface along the lengthwise direction, said protective pad being adjacent to said first outer edge portions, said second outer edge portions, and said intermediate outer edge portions of each of said intermediate base plates.

3. The tool storage device as claimed in claim 2, wherein said first base plate further includes a first end edge portion that interconnects said first outer edge portions and that is opposite to an adjacent one of said bent parts in the widthwise direction, said protective pad being further adjacent to said first end edge portion, said second outer plate surface having a base surface portion that is connected to an adjacent one of said bent parts and that is covered by said protective pad, and an engaging surface portion that is configured for disposing said second connecting member, when said storage unit is in the folded state, said first base plate overlapping said engaging surface portion of said second outer plate surface.

4. The tool storage device as claimed in claim 3, wherein said inner plate surface of said first base plate is defined as a first inner plate surface, said first connecting member having a plurality of through holes that are spaced apart from each other along the lengthwise direction and that extend through said first outer plate surface and said first inner plate surface, said second connecting member having a plurality of protrusions that are disposed on said second outer plate surface, that are spaced apart from each other along the lengthwise direction, and that are capable of respectively and removably engaging said through holes.

5. The tool storage device as claimed in claim 3, wherein said second base plate further includes a plurality of ribs that protrude from said base surface portion and that are connected to said protective pad, said ribs of said second base plate extending along the lengthwise direction and being spaced apart from each other along the widthwise direction, each of said intermediate base plates further including a plurality of ribs that protrude from said intermediate outer plate surface and that are connected to said protective pad, said ribs of each of said intermediate base plates extending along the lengthwise direction and being spaced apart from each other along the widthwise direction.

6. The tool storage device as claimed in claim 1, wherein said storage unit further includes a plurality of support members that respectively correspond to said bent parts, a number of said support members being identical to the number of said bent parts, each of said support members including two protruding bars that are respectively located at two opposite sides of said outer folding surface of a corresponding one of said bent parts in the widthwise direction and that are respectively connected to said outer plate surfaces of two of said base plates between which the corresponding one of said bent parts is connected, each of said protruding bars of each of said support members extending along the lengthwise direction, each of said support members having a movable space that is cooperatively defined by said protruding bars, said outer folding surface of the corresponding one of said bent parts, and said outer plate surfaces of the two of said base plates between which the corresponding one of said bent parts is connected and that extends along the lengthwise direction, when said tool storage device is in the unfolded state, a portion of each of said connecting portions being bent and being accommodated in said movable space of a corresponding one of said support members.

7. The tool storage device as claimed in claim 6, wherein said movable space of each of said support members has a groove that is defined by said outer folding surface of the corresponding one of said bent parts and that extends along the lengthwise direction.

8. The tool storage device as claimed in claim 1, wherein said protective pad is made of a pliable material.

9. The tool storage device as claimed in claim 1, wherein said protective pad is made of an elastic material.
